(19) United States
(12) Patent Application Publication
(10) Pub. No.: US 2005/0256763 A1
(43) Pub. Date: Nov. 17, 2005

(54) System and method for identifying objects of value

(76) Inventor: David M. Bohonnon, Madison, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/188,060

(22) Filed: Jul. 22, 2005

Related U.S. Application Data
(63) Continuation-in-part of application No. 10/646,177, filed on Aug. 22, 2003.
(60) Provisional application No. 60/405,523, filed on Aug. 23, 2002.
(60) Provisional application No. 60/422,269, filed on Oct. 29, 2002.
(60) Provisional application No. 60/590,484, filed on Jul. 23, 2004.

(51) Int. Cl. G08C 19/00

(52) U.S. Cl. 705/13; 705/39; 340/10.1; 340/572.1; 340/5.8

(57) ABSTRACT

A system and method are presented for identifying an object of value during a security assessment. The system includes an identification tag affixed to the object of value, an interrogator, and a data processing system. The identification tag stores information uniquely identifying the object of value. The interrogator includes a sensing antenna and electronic detection circuitry for exciting and reading back the identification information from the identification tag. The interrogator also includes a transmitter and a receiver. The data processing system includes a server, a data store coupled to the server, and a communication network coupling the server and the interrogator. When the interrogator transmits the identification information to the server, the server, in real-time, accesses the data store, retrieves information of interest to personnel performing the security assessment and transmits the information of interest to the interrogator for review by the personnel.

### CROSS REFERENCE TO RELATED APPLICATIONS

This application is a continuation-in-part of U.S. patent application Ser. No. 10/646,177, filed Aug. 22, 2003, which claims the benefit of prior U.S. Provisional Patent Application No. 60/405,523, filed Aug. 23, 2002, and prior U.S. Provisional Patent Application No. 60/422,269, filed Oct. 29, 2002, each of which is incorporated by reference herein in its entirety; and this application claims the benefit of U.S. Provisional Patent Application Ser. No. 60/590,484, filed Jul. 23, 2004, which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The present dislcosure relates generally to systems and methods for identifying objects of value and in particular, to systems and methods for tagging and scanning objects and remotely accessing, in real-time, data related to the objects such as, for example, data indicating ownership and registration, hailing port or garage location, and manufacturer's description of the object of value, for example, a marine vessel, by authorities in the performance of terrorist threat detection, assessment and identification.

Certain objects of value, for example, a marine vessel or vehicle, can be easily moved or transported from one location to the next and, as a result, pose a significant threat with regard to illegal or terrorist activity. Authorities such as, for example, federal, state and municipal authorities require a reliable system for identifying suspicious objects in the field through the remote, real-time access of a reliable source of information.

The inventor has found that some authorities (e.g., federal and state authorities) maintain independent data stores of information regarding objects of value. However, the inventor has discover that there is no real-time, global access to all available information from these data stores for purposes of, for example, threat assessment and detection. Further, perceived deficiencies have been identified with regard to existing commercial products such as, for example, handheld optical and Radio Frequency Identification (RFID) scanners and emitters, optically read and RFID registration stickers, which makes implementation of such technologies in the field by law enforcement and terrorist detection personnel more difficult.

Accordingly, the inventor has realized that a need exists for a reliable and universal data store containing information regarding objects of value and for a system and method for remotely accessing the data store in real-time to permit authorities to locate and review, for example, identification information about an object of value that may be considered a security threat.

### BRIEF SUMMARY

In one aspect, there is provided a system for identifying an object of value during security assessment. The system comprises an identification tag, an interrogator, and a data processing system. The identification tag is affixed to the object of value and includes identification information uniquely identifying the object of value. The interrogator has a sensing antenna and electronic detection circuitry for exciting and reading back the identification information from the identification tag. The data processing system includes a server, a data store coupled to the server, and a communication network coupling the server and the interrogator. When the interrogator transmits the identification information to the server, the server accesses the data store, retrieves information of interest to personnel performing the security assessment and transmits the information of interest to the interrogator for review by said personnel.

In another aspect, there is provided a system for identifying an object of value during security assessment. The system comprises an identification tag, a scanner, a control center, and a data processing system. The identification tag is affixed to the object of value, and stores identification information uniquely identifying the object of value. The scanner has circuitry for optically reading the identification information from the identification tag and a transmitter for transmitting the identification information. The control center is operatively coupled to the scanner for receiving the identification information transmitted therefrom. The data processing system includes a server, a data store coupled to the server, and a communication network coupling the server and the control center. When the control center transmits the identification information to the server, the server accesses the data store, retrieves information of interest to personnel performing the security assessment, and transmits the information of interest to the control center for review by the personnel.

In yet another aspect, there is provided a method for providing information of interest to personnel conducting a security assessment of a vehicle. The method comprises: querying an identification tag affixed to the vehicle using a portable device, the identification tag storing identification information uniquely identifying the vehicle; receiving the identification information at the portable device in response to the querying; transmitting the identification information from the portable device to a data processing system, the data processing system including: a server, and a data store coupled to the server; wherein when the portable device transmits the identification information to the data processing system, the server accesses the data store, retrieves information of interest to personnel performing the security assessment and transmits the information of interest to the portable device for review by the personnel.

### BRIEF DESCRIPTION OF THE DRAWING

Referring now to the drawing wherein like items are numbered alike in the various Figures:

FIG. 1 is a schematic depiction of a system for tagging, scanning, and identifying objects of value; and

FIG. 2 is a schematic depiction of an alternative system for tagging, scanning, and identifying objects of value.

### DETAILED DESCRIPTION

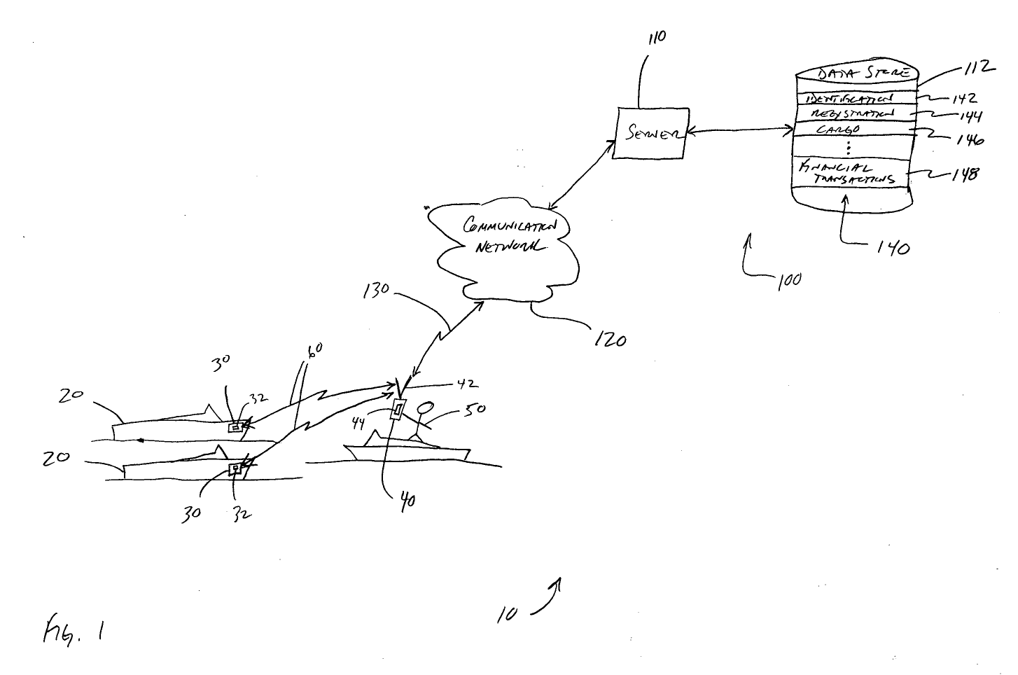

FIG. 1 depicts one embodiment of a system 10 for tagging, scanning and identifying objects of value and in particular, to remotely access, in real-time, data related to the identification of ownership, location and description of the object of value, for example, a marine vessel, motor vehicle, or other type of vehicle. In the embodiment of FIG. 1, the system 10 for tagging, scanning and identifying objects of value, which are shown generally at 20, includes RFID tags 30 embedded or affixed to the objects 20, a portable interrogator 40 having remote communication capabilities, as described below, for real-time access to information of interest to an operator 50 of the interrogator 40. As used herein, real-time access means that the data is accessed substantially without delay (e.g., within a few seconds or less) upon the receipt of a request.

The interrogator 40 includes a sensing antenna 42 and electronic detection circuitry 44, as are generally known in the art, to excite and read back identification information 32 (via signals 60) stored on the RFID tags 30 of the objects 20. The tags 30 may include identification information 32 such as, for example, vessel identification numbers (e.g., hull identification numbers, HIN), vehicle identification numbers (VIN), as are generally known. In one embodiment, the identification information 32 is automatically transmitted from each object of value 20 to the interrogator 40 as part of, for example, a vessel-to-vessel navigational beacon typically used for such purposes as collision avoidance.

The interrogator 40 is coupled to a server 110 of a data processing system 100 through a communication network 120. The interrogator 40 transmits the identification information 32 read back from the tags 30 to the server 110 via signals 130. It should be appreciated that in one embodiment the signals 130 are encrypted or otherwise encoded to prevent manipulation. It should also be appreciated that it is within the scope of the present invention for the signals 130 to be bi-directional and transmitted via the communication network 120 over wired and/or wireless communication connections coupling the interrogator 40 to the server 110. Accordingly, the data processing system 100 may, but need not, be located in proximity to the location of the interrogator 40. The communication network 120 may be a part of a landline telephone network, mobile, cellular or other radiotelephone, telemetry and satellite communication networks as well as part of a global communication network such as, for example, the Internet, an intranet and/or an extranet.

In one embodiment, the data processing system 100 includes a data processing system described in the aforementioned, commonly owned U.S. patent application Ser. No. 10/646,177, which tracks activities and documents related to transactions involving objects of value.

Upon receipt of the identification information 32, the server 110 invokes processes for retrieving information 140, in real-time, including identification information 142 (e.g., vessel call sign, name and HIN, U.S. Coast Guard official number, or vehicle VIN), ownership and registration information 144 (e.g., current and previous state registration information), destination and previous locations or ports of call, hailing port, cargo 146 and/or passenger manifests for each voyage, manufacturer's description of the object (e.g., vessel make, model and dimensions including length, breadth, depth and tonnage), and other information of interest, for example, to authorized official supporting security and/or anti-terrorism initiatives. As shown in FIG. 1, the server 110 is coupled to a data store 112. The data store 112 includes the aforementioned information 140, e.g., identification, ownership and registration, destination, hailing ports, cargo and passenger manifests, and other information related to the objects 20 of interest. Once retrieved, the information 140 of interest corresponding to the subject vehicle is transmitted back (via signals 130) to the interrogator 40.

The information 140 stored within data store 112 may include information such as manufacturer, sales, title and registration information that permits authorized officers to track and/or evaluate a complete chain of title of the subject object, e.g., vessel, motor vehicle, or other vehicle. In one embodiment, the information 140 also includes financial information 148 so that the authorized officers may track and/or evaluate financial transactions involving the object of interest for potentially unusual transactions (e.g., cash sales, transactions involving suspect business entities, vessels with one-way navigational plans, etc.) that may of interest to the officers as they assess a potential security threat.

It should be appreciated that the inventor has found that existing data stores such as, for example, the U.S. Coast Guard's vessel tracking data bases, are not always current. As such, one aspect of the present invention is to agglomerate information with respect to objects (e.g., vessels and other vehicles) from a number of heretofore independent sources such as state registration and manufacturer data bases, to provide an accurate and comprehensive source of past and current information (as described above) regarding object ownership and operation.

Preferably, the interrogator 40 includes a display device or monitor such that the information 140 retrieved from the data store 112 and transmitted back to the interrogator 40 may be visually or graphically presented to the operator 50 of the interrogator 40. For example, the interrogator 40 may be implemented in a portable computing device form factor such as, for example, a personal digital assistant (PDA), handheld or laptop computer and the like. The interrogator 40 permits the display of the information 140 retrieved and transmitted back to personnel in the field that are assessing a perceived security threat. In one embodiment, the field personnel may include, for example, federal, state and municipal law enforcement, transportation security personnel, port authorities and US Customs and Immigration personnel. It should be appreciated that the system 10 may include a plurality of interrogators 40 for use by different field personnel.

It should be appreciated that while illustrated in FIG. 1 as a single data store, the data store 112 may include a plurality of data stores. In one embodiment, the plurality of data stores includes third party data stores such as, for example, data stores maintained by the U.S. Coast Guard including vessel registration information.

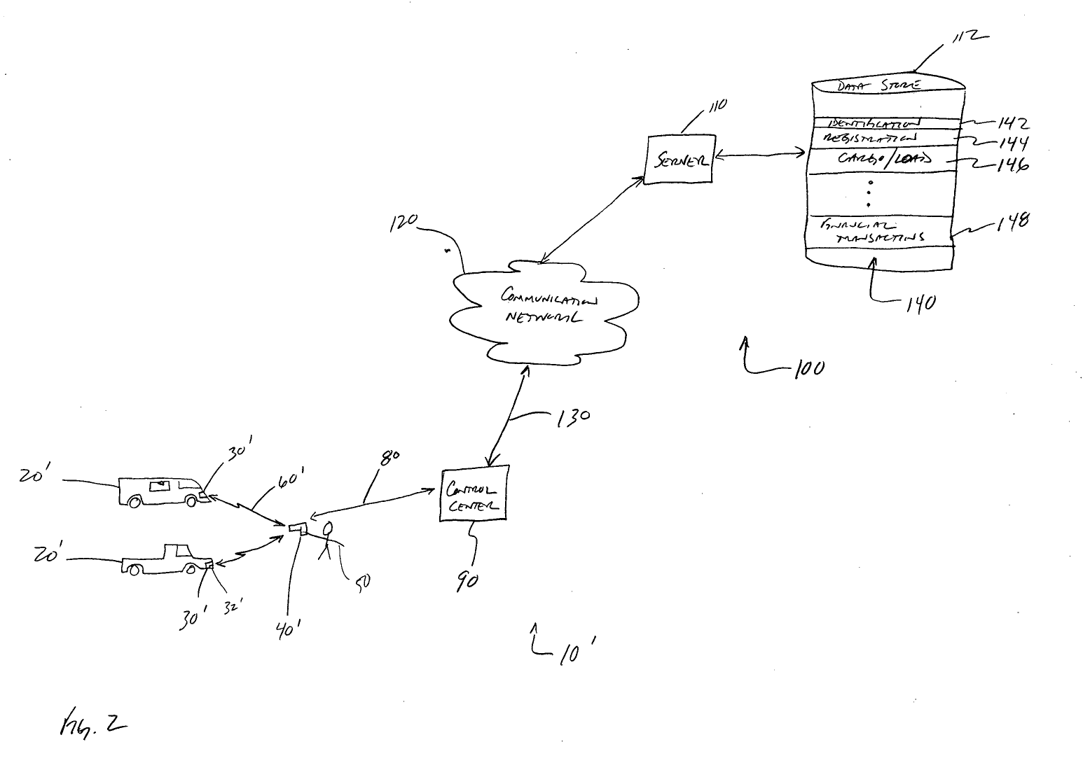

FIG. 2 depicts another embodiment of a system 10′ for tagging, scanning and identifying objects of value and in particular, to remotely access, in real-time, data related to the identification of ownership, location and description of the object of value, for example, a marine vessel, motor vehicle, or other vehicle. In the embodiment of FIG. 2, the system 10′ for tagging, scanning and identifying objects of value, shown generally at 20′, includes optical bar code tags 30′ affixed to the objects 20′, a portable handheld scanner 40′, as is generally known in the art, having remote communication capabilities for real-time access to information of interest to the operator 50 of the scanner 40′. The scanner 40′ includes circuitry for optically reading identification information 32′ (via signals 60′) stored within the bar coded tags 30′ of the objects 20′. In one embodiment, the tags 30′ include identification information 32′ such as, for example, vessel identification numbers (e.g., hull identification numbers), vehicle identification numbers (e.g., VIN numbers), as are generally known.

As illustrated in FIG. 2, the scanner 40′ transmits (via signals 80) the identification information 32′ to a control center 90 located in close proximity to the scanner 40′. Upon receipt of the transmitted signals, processes within the control center 90 transmit the identification information 32′ to the data processing system 100 and, in particular, the server 110 therein. It should be appreciated that the control center 90 may coordinate and direct collection of identification information (such as information 32′) from a plurality of personnel using scanners similar to scanner 40′ during a coordinated security assessment operation. As described above, the server 110, upon receipt of the identification information 32′, invokes processes for retrieving information 140, in real-time, including the identification information 142, the ownership and registration information 144, the destination and previous locations or ports of call, the cargo 146, and other information of interest to authorized official supporting security and/or anti-terrorism initiatives. The server 110 transmits the information 140 to the control center 90. Personnel at the control center may evaluate the information for a coordinated response thereto and/or transmit the information 140 to the scanner 40′ for exhibition to the personnel 50 operating the scanner 40′.

It should be understood that any of the features, characteristics, alternatives or modifications described regarding a particular embodiment herein may also be applied, used, or incorporated with any other embodiment described herein. For example, the system 10 of FIG. 1 may include one or more scanners 40′ in addition to, or in lieu of, the one or more interrogators 40, with the scanners 40′ and/or interrogators 40 communicating with the server 110 via the network 120. Similarly, the system 10′ of FIG. 2 may include one or more interrogator 40 in addition to, or in lieu of, the one or more scanners 40′, with the interrogators 40 and/or scanners 40′ communicating with the server 110 via the control center 90. It is also contemplated that, in system 10′, some interrogators 40 and/or scanners 40′ may communicate with the server 110 via the control center 90 and the network 120, while others may communicated with the server 110 directly via the network 120.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A system for identifying an object of value during security assessment, comprising:
an identification tag affixed to said object of value, said identification tag storing identification information uniquely identifying said object of value;
an interrogator having a sensing antenna and electronic detection circuitry for exciting and reading back said identification information from said identification tag; and
a data processing system, including:
a server;
a data store coupled to said server; and
a communication network coupling said server and said interrogator;
wherein when said interrogator transmits said identification information to said server, said server accesses said data store, retrieves information of interest to personnel performing said security assessment and transmits said information of interest to said interrogator for review by said personnel.

2. The system of claim 1, wherein said identification information includes at least one of a vessel identification number and a vehicle identification number.

3. The system of claim 1, wherein said identification tag is comprised of a radio frequency identification tag.

4. The system of claim 1, wherein said interrogator includes a display device for exhibiting said information of interest.

5. The system of claim 1, wherein said information of interest is comprised of at least one of: vessel call sign, vessel name, hull identification number, U.S. Coast Guard official number, vehicle identification number, vehicle ownership, title and registration information, destination, previous locations or ports of call, hailing port, cargo and passenger manifests, manufacturing information, sales information, financial transaction information including parties to a transaction involving said object of value, and other information of interest to said personnel supporting security and/or anti-terrorism initiatives.

6. A system for identifying an object of value during security assessment, comprising:
an identification tag affixed to said object of value, said identification tag storing identification information uniquely identifying said object of value;
a scanner having circuitry for optically reading said identification information from said identification tag and a transmitter for transmitting said identification information;
a control center operatively coupled to said scanner for receiving said identification information transmitted therefrom; and
a data processing system, including:
a server;
a data store coupled to said server; and
a communication network coupling said server and said control center;
wherein when said control center transmits said identification information to said server, said server accesses said data store, retrieves information of interest to personnel performing said security assessment and transmits said information of interest to said control center for review by said personnel.

7. The system of claim 6, wherein said identification tag is comprised of an optical bar code tag.

8. The system of claim 6, wherein said identification information includes at least one of a vessel identification number and a vehicle identification number.

9. The system of claim 6, wherein said identification tag is comprised of a radio frequency identification tag.

10. The system of claim 6, wherein said scanner includes a display device for exhibiting said information of interest.

11. The system of claim 6, wherein said information of interest is comprised of at least one of: vessel call sign, vessel name, hull identification number, U.S. Coast Guard official number, vehicle identification number, vehicle ownership, title and registration information, destination, previous locations or ports of call, hailing port, cargo and passenger manifests, manufacturing information, sales information, financial transaction information including parties to a transaction involving said object of value, and other information of interest to said personnel supporting security and/or anti-terrorism initiatives.

12. A method for providing information of interest to personnel conducting a security assessment of a vehicle, the method comprising:
querying an identification tag affixed to said vehicle using a portable device, said identification tag storing identification information uniquely identifying said vehicle;
receiving said identification information at said portable device in response to said querying;
transmitting said identification information from said portable device to a data processing system, said data processing system including:
a server, and
a data store coupled to said server;
wherein when said portable device transmits said identification information to said data processing system, said server accesses said data store, retrieves information of interest to personnel performing said security assessment and transmits said information of interest to said portable device for review by said personnel.

13. The method of claim 12, wherein said identification information includes at least one of a vessel identification number and a vehicle identification number.

14. The method of claim 12, wherein said identification tag includes at least one of: a radio frequency identification tag and an optical bar code tag.

15. The method of claim 12, wherein said portable device includes a display device for exhibiting said information of interest.

16. The method of claim 12, wherein said information of interest is comprised of at least one of: vessel call sign, vessel name, hull identification number, U.S. Coast Guard official number, vehicle identification number, vehicle ownership, title and registration information, destination, previous locations or ports of call, hailing port, cargo and passenger manifests, manufacturing information, sales information, financial transaction information including parties to a transaction involving said object of value, and other information of interest to said personnel supporting security and/or anti-terrorism initiatives.
